(19) United States
(12) Patent Application Publication
(10) Pub. No.: US 2015/0149068 A1
(43) Pub. Date: May 28, 2015

(54) METHODS AND SYSTEMS FOR AUTO PREDICTING USING A NAVIGATION SYSTEM

(71) Applicant: GM GLOBAL TECHNOLOGY OPERATIONS LLC, Detroit, MI (US)

(72) Inventors: GEORGE RITCHIE, NANAIMO (CA); JARVIS CHAU, MARKHAM (CA); MARK A. MANICKARAJ, AJAX (CA)

(73) Assignee: GM GLOBAL TECHNOLOGY OPERATIONS LLC, Detroit, MI (US)

(21) Appl. No.: 14/089,078

(22) Filed: Nov. 25, 2013

(51) Int. Cl. G01C 21/34

(52) U.S. Cl. CPC G01C 21/34
USPC 701/400

(57) ABSTRACT

Methods and systems are provided for communicating navigation information to a user. In one embodiment, a method includes determining a trip that is performed by a vehicle; determining a time and a route associated with the trip; and sending the time and the route associated with the trip from the vehicle to a wireless electronic device.

### TECHNICAL FIELD

The technical field generally relates to methods and systems for a navigation system of a vehicle, and more particularly to methods and systems for communicating navigation information from the navigation system to a user of a vehicle.

### BACKGROUND

Mobile, in-vehicle information systems, such as navigation systems, have become commonplace in vehicles such as automobiles, trucks, sport utility vehicles, etc. The navigation systems typically use a GPS navigation device to locate the vehicle and to display a map of the vehicle location on a display screen. Some systems additionally provide directions or route information for the user based on an intended destination. Depending on the system, the user may also interact with the navigation system to update the vehicle position and/or intended destination, typically by entering data on a touch screen or keyboard associated with the display screen.

It is common for a user of a vehicle to make trips from one location to another location at a particular time of day. For example, a user may drive from home to work and from work to home every day. Accordingly, it is desirable to provide methods and systems for communicating navigation information about the trip to a user. In addition, it is desirable to provide methods and systems for communicating the navigation information about the trip to the user prior to the user driving the trip. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for communicating navigation information to a user. In one embodiment, a method includes: determining a trip that is performed by a vehicle; determining a time and a route associated with the trip; and sending the time and the route associated with the trip from the vehicle to a wireless electronic device.

In another embodiment, a method includes: receiving, by a wireless electronic device, a time and a route that is associated with a trip that has been performed by a vehicle; and generating by the wireless electronic device, a notification to a user based on the time and the route that is associated with the trip.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a navigation information system that includes a wireless end device and a vehicle in accordance with various embodiments;

FIGS. 2 and 3 are functional block diagrams illustrating functional modules of the navigation information system in accordance with various embodiments;

FIG. 4 is an illustration of a trip datastore of the navigation information system in accordance with various embodiments; and

FIGS. 5-11 are flowcharts illustrating navigation information methods that may be performed by the navigation information system of FIG. 1 in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description

It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

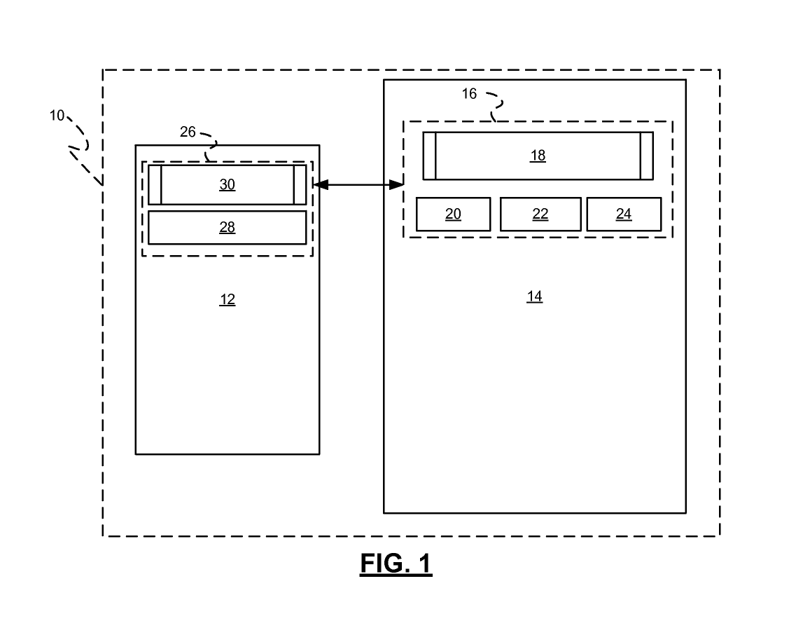

FIG. 1 is a functional block diagram of a navigation information system 10 in accordance with various embodiments. Although the figures shown herein depict an example with certain arrangements of elements, additional intervening elements, devices, features, or components may be present in actual embodiments. It should also be understood that FIG. 1 is merely illustrative and may not be drawn to scale.

As shown, the navigation information system 10 includes a wireless end device (WED) 12 that is configured to communicate with a vehicle 14. The vehicle 14 may be an automobile, an aircraft, a spacecraft, a watercraft, a sport utility vehicle, or any other type of vehicle 14. The vehicle 14 includes a navigation system 16 (among other elements not shown) that displays navigation information to a user of the system through an interactive navigation interface 18. For example, the navigation information may include map and route information associated with a particular location or destination.

In general, the navigation system 16 includes one or more user interface devices 20, a global positioning system (GPS) device 22, and a navigation control module 24. The user interface device(s) 20 includes a display and at least one input device. The display may be any display capable of displaying the navigation interface 18, such as a suitably configured liquid crystal display (LCD), plasma, cathode ray tube (CRT), or heads-up display. The input device may be an input device capable of receiving input from a user when interacting with the navigation interface 18. In various embodiments, the input device may be a part of the display such as, but not limited to, a touch screen device, and/or may be separate from the display such as, a keyboard or keypad, a voice recognition system, a cursor control device, a joystick or knob, or a selection button that is associated with the display.

The GPS device 22 communicates with GPS satellites (not shown) to derive a current location (e.g., latitude and longitude coordinates) of the vehicle 14 and, in some instances, to determine map information associated with the current location of the vehicle 14. The navigation control module 24 interacts with the GPS device 22 to display route information to a user. For example, the navigation control module 24 provides route information to the user based on a starting or current location of the vehicle 14 and a selected destination. The route information provided by the navigation control module 24 may generally include a map of the route, a description of sections or segments that make up the route (e.g., road or highway segments, intersections, on/off ramps, city blocks, geographic regions, etc.), and driving directions.

As will be discussed in further detail below, the navigation control module 24 monitors the route information provided to the user to determine frequently traveled trips, hereinafter referred to as trips of interest. The navigation control module 24 determines and stores time and route information associated with the various trips of interest and communicates the stored information to the WED 12.

The WED 12 may be a smart phone, a tablet, a Bluetooth enabled gadget, or any other electronic device that includes one or more user interface devices and that is capable of communicating with the vehicle 14 using a short range and/or long range communication protocol. The WED 12 includes a navigation companion system 26 (e.g., that is loaded to memory of the WED 12 as an application) that communicates with the navigation system 16 of the vehicle 14. In general, the navigation companion system 26 includes a navigation companion module 28 that manages a navigation companion interface 30 based on the time and route information about the various trips of interest received from the navigation control module 24. As will be discussed in further detail below, the navigation companion module 28 monitors traffic activity based on the time and route information for the various trips of interest. Additionally, the navigation companion module 28 generates notifications to a user based on the traffic activity via the navigation companion interface 30.

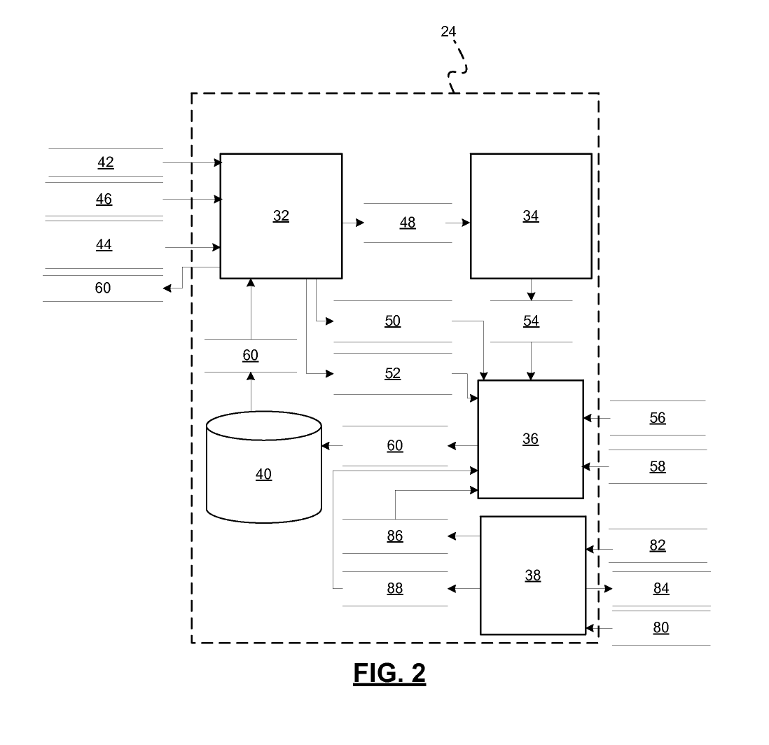

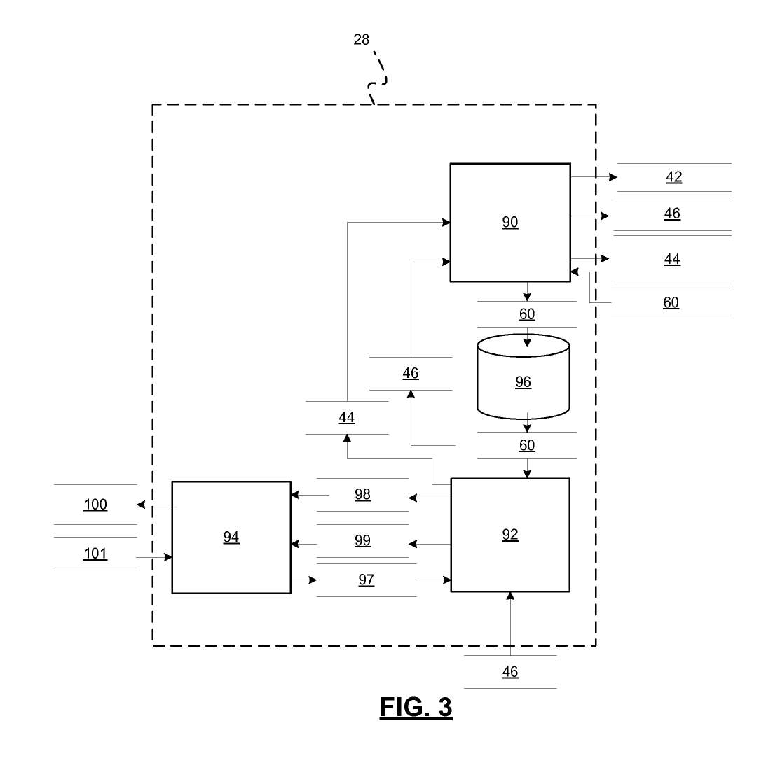

Referring now to FIGS. 2 and 3, functional block diagrams illustrate various embodiments of the navigation control module 24 and the navigation companion module 28 of the navigation information system 10. Various embodiments of navigation control modules 24 and the navigation companion modules 28 according to the present disclosure may include any number of sub-modules. As can be appreciated, the sub-modules shown in FIGS. 2 and 3 may be combined and/or further partitioned to similarly facilitate the communication of navigation information to a user through the navigation interface 18 and the companion interface 30.

In various embodiments, as shown in FIG. 2, the navigation control module 24 includes a companion communication module 32, a user identifier module 34, a trip data manager module 36, a navigation interface manager module 38, and a trips data datastore 40. The companion communication module 32 communicates information to and from the navigation companion module 28. For example, the companion communication module 32 receives identifier data 42, searched destination data 44, and calendar data 46 from the navigation companion module 28 and provides information from the data 42-46 available to the other modules 34-38. The identifier data 42 includes an identifier 48 of the WED 12 that may be assigned by the WED 12 and identified by the navigation companion module 28 or that may be assigned by the navigation companion module 28. The navigation companion module 28, for example, may send the identifier data 42 when it is detected that the WED 12 is in a particular proximity to the vehicle 14 or when a request from the navigation control module 24 is received (e.g., based on an ignition on status of the vehicle 14). The searched destination data 44 includes searched destinations and routing information 50 that is generated by a user when interacting with the companion interface 30 of the navigation companion module 28. The calendar data 46 includes upcoming destinations 52 that are scheduled on a calendar of the WED 12.

The companion communication module 32 communicates trip data 60 that includes trips of interest information to the companion module 28. For example, upon completion of a trip, the companion communication module 32 pushes the trip data 60 to the companion module 28.

The user identifier module 34 receives the identifier 48 from the companion communication module 32. The user identifier module 34 recognizes whether the identifier 48 is associated with a particular user (e.g., that was associated through a pre-pairing process performed between the WED 12 and the vehicle 14). The user detection module 34 identifies the associated user as the current user of the vehicle 14 and sends the identified user 54 to the trip data manager module 36.

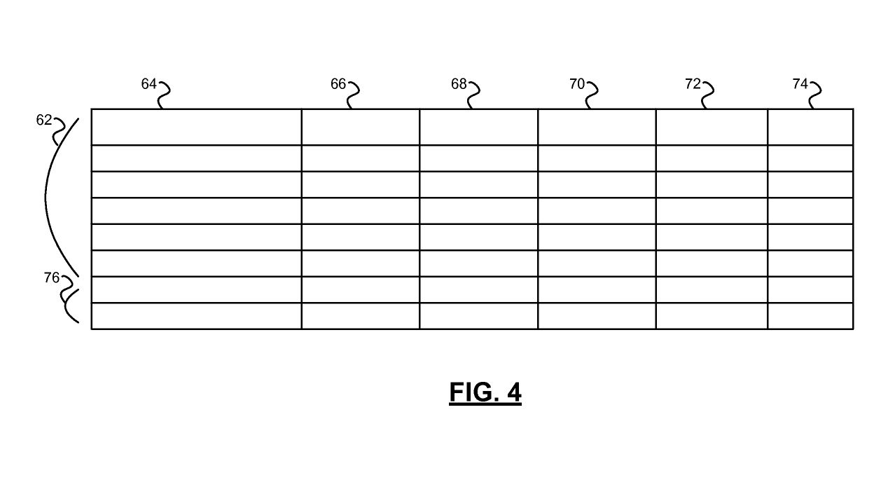

The trip data manager module 36 receives as input the identified user 54, time data 56, and GPS data 58. The time data 56 and the GPS data 58 may be received from the GPS device 22 and may include a time the vehicle 14 is determined to be at particular coordinates. Based on the inputs, the trip data manager module 36 identifies trips of interest for the identified user 54 and stores trip data 60 for the trips of interest in the trips data datastore 40. For example, as shown in FIG. 4, the trip data manager module 36 determines a top six (or any other number) trips of interest 62 based on a frequency of traveling from a particular location to a particular destination. For each top trip of interest 62, the trip data manager module 36 stores a name 64 (e.g., home to work, work to home, work to gym, etc.), coordinates 66 of the starting location (e.g., coordinates that define a particular radius around the coordinates of the starting location), coordinates 68 of the ending location (e.g., coordinates that define a particular radius around the coordinates of the ending location), coordinates along a route 70 taken between the starting location and the ending location, a departure time 72, and a frequency of the trip 74. Additionally, the trip data manager module 36 stores two (or any other number) volatile trips of interest 76 based on a frequency of traveling from a particular location to a particular destination. For each volatile trip of interest 76, the trip data manager module 36 similarly stores a name 64 (e.g., home to work, work to home, work to gym, etc.), coordinates 66 of the starting location (e.g., coordinates that define a particular radius around the coordinates of the starting location), coordinates 68 of the ending location (e.g., coordinates that define a particular radius around the coordinates of the ending location), coordinates along a route 70 taken between the starting location and the ending location, a departure time 72, and a frequency of the trip 74.

In various embodiments, once the frequency associated with a volatile trip of interest 76 reaches a particular threshold or is greater than a frequency of a top trip of interest 62, the trip data manager module 36 moves the volatile trip of interest 76 to a top trip of interest 62.

With reference back to FIG. 2, the navigation interface manager module 38 receives route data 80 and user input data 82. The route data 80 includes route information for an upcoming trip and can be received from the GPS device 22 or other module. The user input data 82 is generated based on a user's interaction with the navigation interface 18. Based on the inputs 80 and 82, the navigation interface manager module 38 generates interface data 84 that is used to display the navigation interface 18. For example, the navigation interface manager module 38 generates interface data 84 that contains the route information associated with the particular upcoming trip. In another example, the navigation interface manager module 38 generates interface data 84 that includes prompts for selecting a name of a trip and selecting a route to be associated with the trip. In various embodiments, the user input data 82 includes name data 86 and route selection data 88 that are received based on a user's interaction with the prompts that are displayed by the navigation interface 18. The navigation interface manager module 38 provides the name data 86 and the route selection data 88 for use by the trip data manager module 36.

In various embodiments, as shown in FIG. 3, the navigation companion module 28 includes a navigation system communication module 90, a notification determination module 92, a companion interface manager module 94, and a trips data datastore 96. The navigation system communication module 90 communicates information to and from the navigation control module 24. For example, the navigation communication module 90 receives the trip data 60 sent by the navigation control module 24. The navigation system communication module 90 stores the trip data 60 in the trips data datastore 96. In another example, the navigation system communication module 90 sends the searched destination data 44, and the calendar data 46 (i.e., that is received from the notification determination module 92) to the navigation control module 24.

The notification determination module 92 receives as input the trip data 60, calendar data 46, and selection data 97. The calendar data 46 may be received from a calendar of the WED 12 and may include scheduled trips or destinations. The selection data 97 may be received from the companion interface manager module 94 and includes a selection of a trip or destination. Based on the inputs, the notification determination module 92 determines a next trip of interest. For example, if the selection data 97 indicates a trip or destination that has been selected, then the next trip of interest is the next trip or a trip determined from the selected destination. If, however, the selection data 97 does not indicate a trip or destination that has been selected, the next trip of interest is based on the time of the scheduled event (i.e. from the calendar data 46) or the time associated with the trips of interest. The notification determination module 92 determines traffic activity 98 for the route associated with the next top trip of interest at a predetermined time before the time of the next trip of interest. The notification determination module 92 determines any time delays 99 based on the traffic activity 98 for the route associated with the next top trip of interest.

The companion interface manager module 94 receives the traffic activity 98 and the time delay 99 for the next top trip of interest. Based on the traffic activity 98 and the time delay 99, the companion interface manager module 94 generates interface data 100 that is used to display the companion interface 30. For example, the navigation interface manager module 94 generates interface data 100 that contains the traffic activity 98 and the time delay 99. In addition, the navigation interface manager module 94 generates interface data 100 that contains the route associated with the traffic activity 98.

In various embodiments, the interface data 100 contains a listing of the trips of interest from the trip data 60. The companion interface manager module 94 receives user input 101 indicating a selection of one of the trips of interest or another destination. The companion interface manager module 94 provides the selection 97 to the notification determination module 92 for determination of the time delay 99 and the traffic activity 98 associated with that selection.

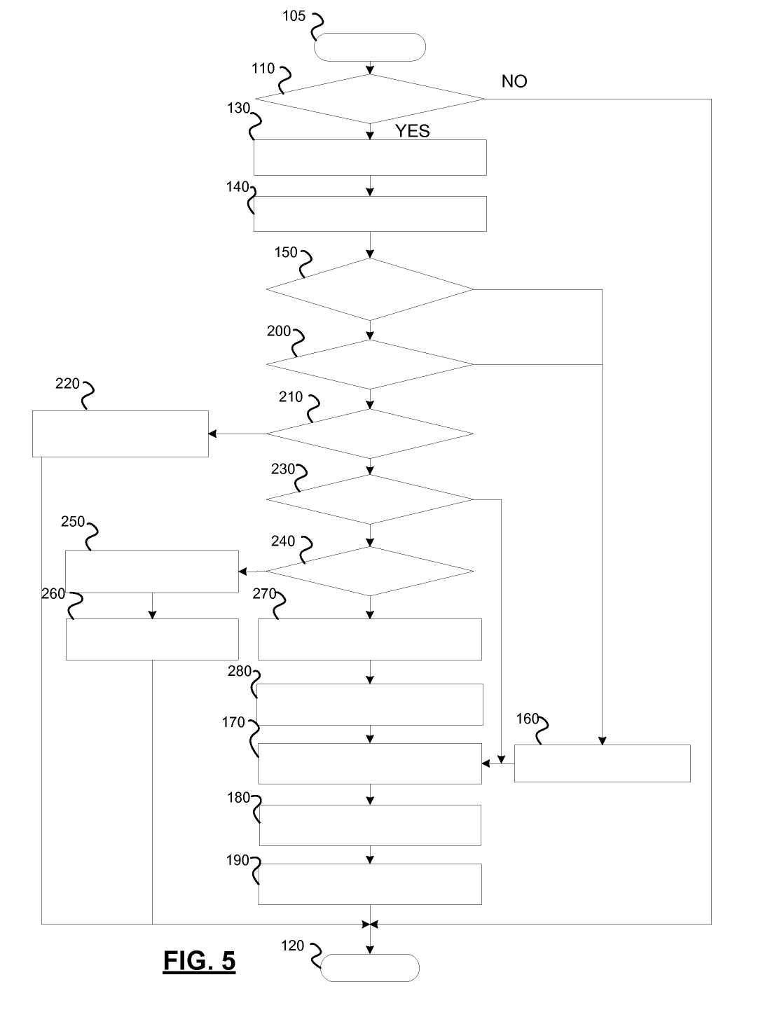

Referring now to FIGS. 5-11 and with continued reference to FIGS. 1-4, flowcharts illustrate navigation information communication methods that may be performed by the modules of the navigation information system 10 in accordance with various embodiments. As can be appreciated in light of the disclosure, the order of operation within the methods is not limited to the sequential execution as illustrated in FIGS. 5-11, but may be performed in one or more varying orders as applicable and in accordance with the present disclosure. As can further be appreciated, one or more steps of the methods may be added or removed without altering the spirit of the method.

With reference to FIG. 5, a flowchart illustrates exemplary sequences of steps of a method for managing the trip data 60 of the navigation information system 10 in accordance with exemplary embodiments. The method may begin at 105. It is determined whether the vehicle 14 is turned on (e.g., by evaluating a mode of the vehicle 14) at 110. If the vehicle 14 was not turned on (e.g., the vehicle is in an accessory mode or other mode) at 110, the method may end at 120. If, however, the vehicle 14 is turned on at 110, a user of the vehicle 14 is determined, for example, by detecting the WED 12 to be within the vehicle 14 at 130 as discussed above and by selecting a user that is associated with the identifier 48 of the WED 12 at 140.

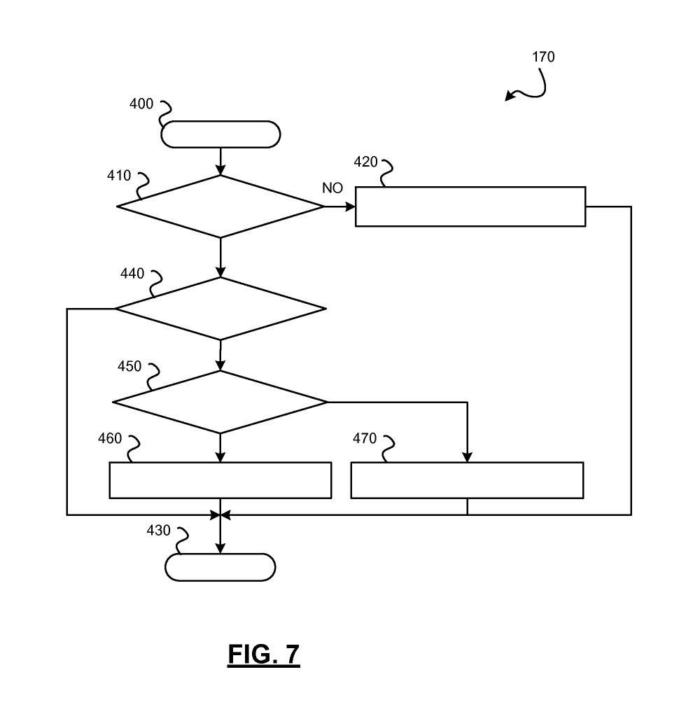

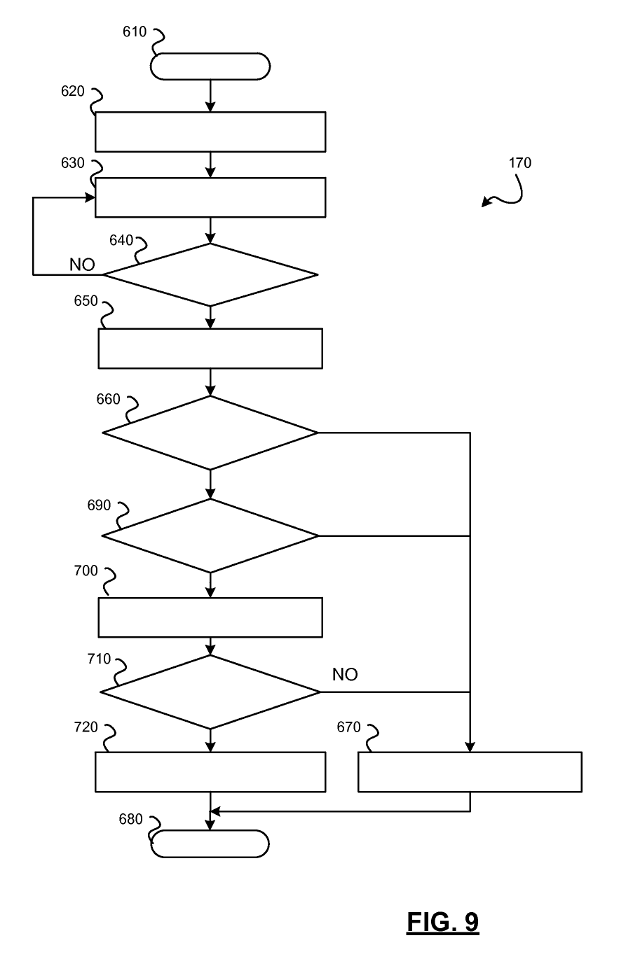

It is determined whether that user has performed a destination search using the navigation system 16 or the WED 12 at 150. If the user has performed a destination search at 150, the trip associated with the destination search is determined to be a trip of interest and the trip data 60 is saved or updated at 160, as will be discussed in more detail with regard to FIG. 7. The route information associated with the trip is displayed on the navigation system 16 at 170. Thereafter, as the vehicle 14 is driving to the destination, the route coordinates 68 are collected at 180, as will be discussed in more detail with regard to FIG. 9. Once the vehicle 14 arrives at the destination, the trip data 60 is communicated (e.g., pushed) to the navigation companion system 26 on the WED 12 at 190. Thereafter, the method may end at 120.

If it is determined that the user has not performed a destination search at 150, it is determined whether there is a calendar event scheduled at or near the current time at 200. If it is determined that there is a calendar event scheduled at 200, then the trip data 60 is saved or updated at 160, as will be discussed in more detail with regard to FIG. 7. The route information is displayed on the navigation system 16 at 170. Thereafter, as the vehicle 14 is driving to the destination, the route coordinates 70 are collected at 180, as will be discussed in more detail with regard to FIG. 9. Once the vehicle 14 arrives at the destination, the updated trip data 60 is communicated (e.g., pushed) to the navigation companion system 26 on the WED 12 at 190. Thereafter, the method may end at 120.

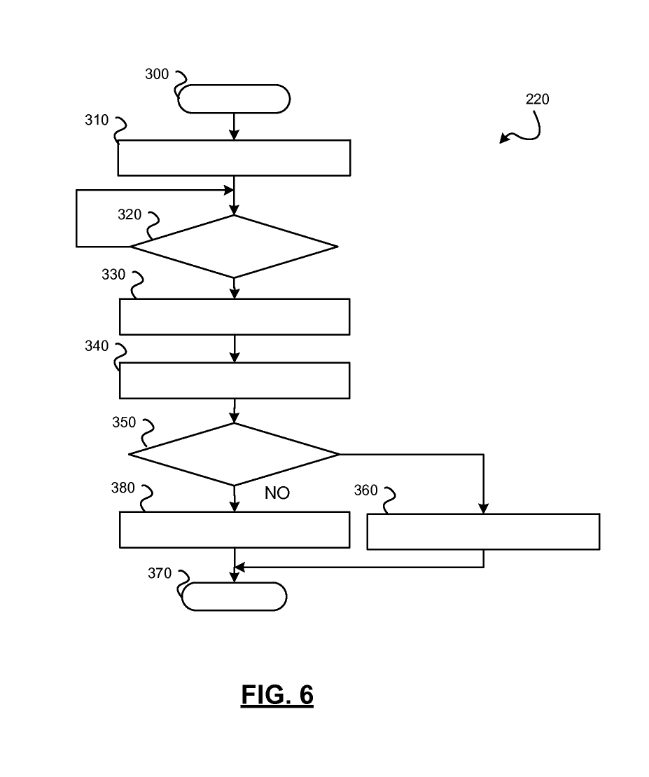

If, at 200, it is determined that a calendar event is not scheduled at or near the current time, it is determined whether there is a trip that is regular for this time at 210. If there is not a trip that is regular for this time at 210, the current location is managed at 220, as will be discussed in more detail with regard to FIG. 6. Thereafter, the method may end at 120.

If, at 210, there is a trip that is regular for this time, it is determined whether the trip is one of the top trips of interest at 230. If it is determined that the trip is one of the top trips of interest 62 at 230, the route information is displayed on the navigation system 16 at 170. Thereafter, as the vehicle 14 is driving to the destination, the route coordinates 70 are collected at 180, as will be discussed in more detail with regard to FIG. 9. Once the vehicle 14 arrives at the destination, the updated trip data 60 is communicated (e.g., pushed) to the navigation companion system 26 on the WED 12 at 190. Thereafter, the method may end at 120.

If, at 230, the trip is not one of the top trips of interest 62, it is determined whether the trip is a volatile trip of interest 76 at 240. If the trip is a volatile trip of interest 76 at 240, the trip data 60 is updated by swapping the volatile trip of interest 76 with one of the top six trips of interest 62 at 250 and the map information is displayed without any routing information at 260. Thereafter, the method may end at 120.

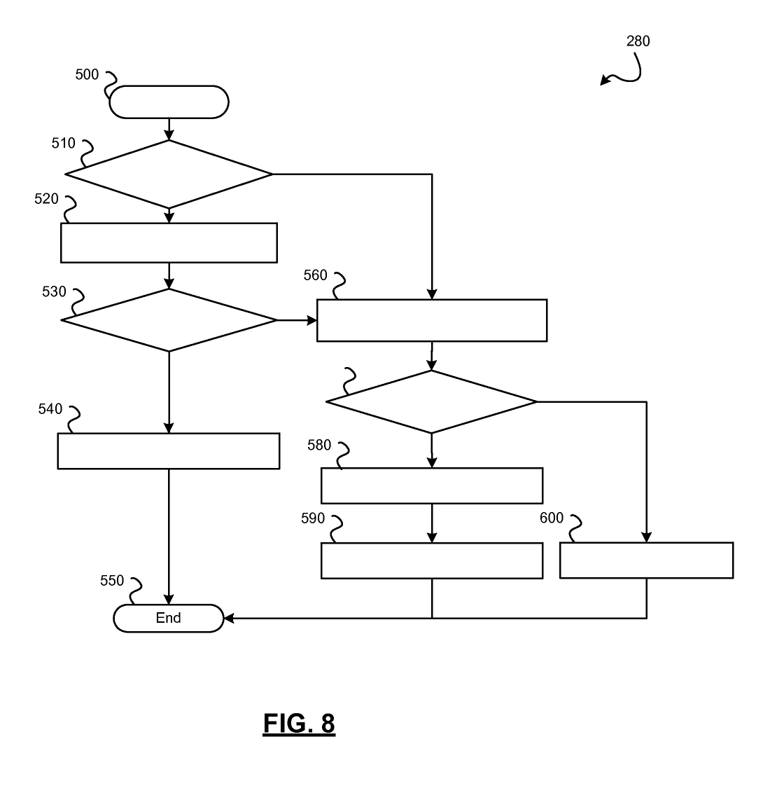

If, at 240, the trip is not a volatile trip of interest 76 at 240, the data for the lowest priority volatile position is replaced with the data of the new trip of interest that is associated with the destination at 270. The trip name is determined and stored at 280, as will be discussed in more detail with regard to FIG. 8. The route information is displayed on the navigation system 16 at 170. Thereafter, as the vehicle 14 is driving to the destination, the routing coordinates 70 are collected at 180, as will be discussed in more detail with regard to FIG. 9. Once the vehicle 14 arrives at the destination, the updated trip data 60 is pushed to the navigation companion system 26 on the WED 12 at 190. Thereafter, the method may end at 120.

With reference to FIG. 6, a flowchart illustrates exemplary sequences of steps of a method for managing the current location of step 220 in accordance with exemplary embodiments. The method may begin at 300. The starting coordinates 66 (e.g., coordinates that define a particular radius around the coordinates of the starting location) of the trip are saved at 310. It is determined whether the vehicle 14 has been put in park at 320. If the vehicle 14 has been put in park at 320, it is assumed that the vehicle 14 has arrived at the destination and the ending coordinates 68 (e.g., coordinates that define a particular radius around the coordinates of the ending location) of the trip are saved at 330. The distance associated with the trip is computed at 340. If, at 350, the distance is less than a predetermined threshold (e.g., five kilometers), then the coordinates data is discarded at 360. Thereafter, the method may end at 370. If, however, the distance is greater than the predetermined threshold (e.g., five kilometers, or other distance), then the coordinates data is saved in a volatile position at 380, and the method may end at 370.

With reference to FIG. 7, a flowchart illustrates exemplary sequences of steps of a method for saving or updating the route information of step 170 in accordance with exemplary embodiments. The method may begin at 400. It is determined whether the trip is a trip of interest at 410. If the trip is not a trip of interest at 410, the trip data is saved as in a volatile position as a volatile trip of interest 76 at 420, and the method may end at 430. If, at 410, the trip is saved as a trip of interest, it is determined whether the trip is a top trip of interest 62 at 440. If the destination is a top trip of interest 62 at 440, the method may end at 430.

If, however, the trip is not a top trip of interest 62 at 440, it is determined whether the trip is a volatile trip of interest 76 at 450. If the trip is a volatile trip of interest 76 at 450, the data of the volatile trip of interest is swapped with data of a top trip of interest at 460. Thereafter, the method may end at 430. If, however, the trip is not a volatile trip of interest 76 at 450, data of a top trip of interest 62 is replaced with the trip data at 470. Thereafter, the method may end at 430.

With reference to FIG. 8, a flowchart illustrates exemplary sequences of steps of a method for naming a trip of step 280 in accordance with exemplary embodiments. The method may begin at 500. It is determined whether a work and home trip of interest has been saved at 510. If a work and home trip of interest has not been saved at 510, the user is prompted to enter whether the trip is a work, home or other destination at 520. If the user enters that the trip is for either home or work at 530, the trip of interest is named “work to home” or “home to work” depending on the user input at 540. Thereafter, the method may end at 550.

If at 530, the user enters that the trip is not home or work, the user is prompted to enter whether the trip is important at 560. If the user enters that the trip is important at 570, the user is prompted to enter the trip name at 580 and the name is received and stored at 590. Thereafter, the method may end at 550.

If the user enters that the trip is not important at 570, the trip is stored with a name based on the address and a low priority or frequency is assigned at 600. Thereafter, the method may end at 550.

If, at 510, the work and home trips of interest have already been saved, the user is prompted to enter whether the trip is important at 560. If the user enters that the trip is important at 570, the user is prompted to enter the trip name at 580 and the name is received and stored at 590. Thereafter, the method may end at 550.

If the user enters that the trip is not important at 570, the trip is stored with a name based on the address and assigned a low priority or frequency at 600. Thereafter, the method may end at 550.

With reference to FIG. 9, a flowchart illustrates exemplary sequences of steps of a method for collecting route data 70 for the current trip of step 190 in accordance with exemplary embodiments. The method may begin at 610. Starting coordinates of the location are saved at 620. The route coordinates 70 of the vehicle 14 are thereafter saved every five kilometers (or other distance) at 630 until the vehicle 14 is put in park at 640. Once the vehicle 14 is put in park at 640, ending coordinates are saved at 650. It is determined whether the starting coordinates and the ending coordinates are within a predetermined radius (e.g., 500 kilometers or other distance) of the starting location and the ending location of a trip of interest (i.e., either a volatile trip of interest 76 or a top trip of interest 62) at 660. If the coordinates are not within a predetermined radius (e.g., where the radius is defined by the starting coordinates 66 and the ending coordinates 68) of a trip of interest at 660, the data is discarded at 670, and the method may end at 680.

If, however, the coordinates are within a predetermined radius (e.g., where the radius is defined by the starting coordinates 66 and the ending coordinates 68) of a trip of interest at 660, it is determined whether the route is the usual route for this trip of interest at 690. If the route is the usual route for the trip of interest at 690, the data is discarded at 670, and the method may end at 680.

If, however, the route is not the usual route for the trip of interest at 690, the user is prompted to enter whether the user would like to update the route for this trip of interest at 700. If the user enters no at 710, the data is discarded at 670, and the method may end at 680. If the user enters yes at 710, the route stored for the trip of interest is updated with the new route at 720, and the method may end at 680.

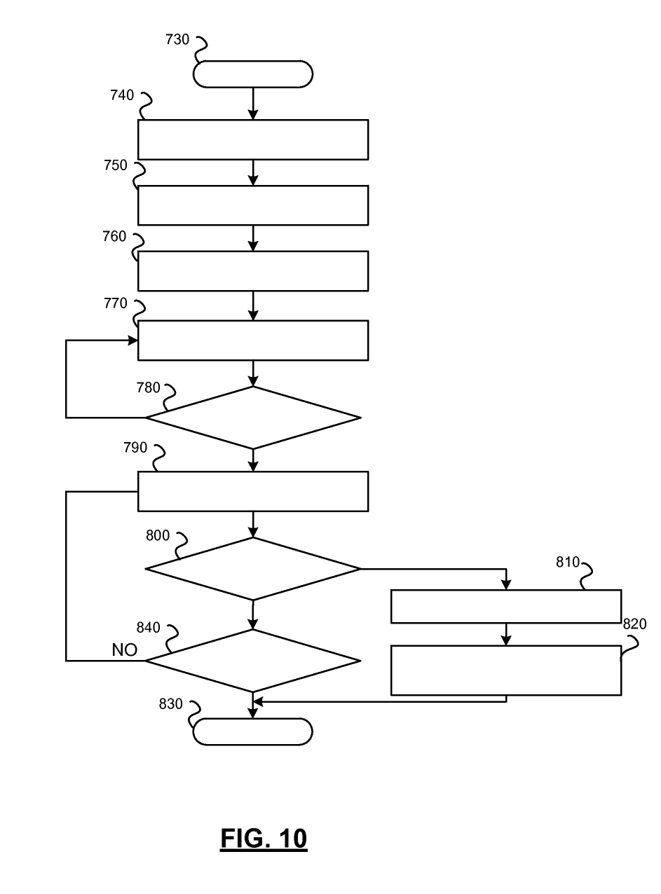

With reference to FIG. 10, a flowchart illustrates exemplary sequences of steps of a method for automatically providing traffic warnings by the navigation companion system 26 in accordance with exemplary embodiments. The method may begin at 730. The companion module 28 receives and stores the top trips of interest 62 at 740. The departure time 72 for the next trip of the top trips of interest is determined at 750. The wake-up time for the next trip (e.g., 30 minutes before the time for the next trip) is set based on the departure time 72 for the next trip at 760. The calendar events that trigger a trip are stored at 770.

The current time is then monitored at 780. If the current time is the wake-up time for the next trip or the calendar event at 780, the traffic along the route associated with the next destination is checked at 790. If any one of the sections or segments of the route indicates heavy traffic at 800, an alternate route for that segment or the entire route is determined at 810, and the driver is alerted to the heavy traffic and the alternate route at 820. Thereafter, the method may end at 830.

If, however, not one of the segments or sections of the route indicates heavy traffic at 800, it is determined whether the current time is the departure time 72 at 840, if the current time is not the departure time 72 at 840, then the traffic is checked at a next interval (e.g., in ten minutes or some other time interval) at 790 and the method continues until the departure time 72 is reached at 840. Thereafter, the method ends at 830.

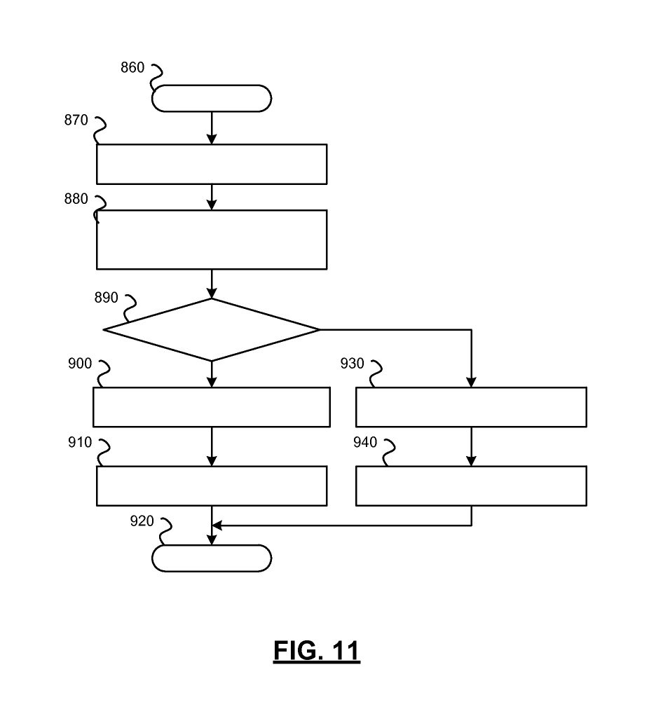

With reference to FIG. 11, a flowchart illustrates exemplary sequences of steps of a method for manually checking traffic by the navigation companion system 26 in accordance with exemplary embodiments. The method may begin at 860. The manual request to open the companion module 28 is received at 870. The user is prompted to enter whether they would like to check the traffic for the next trip or for another trip at 880. If the user enters the next trip at 890, the traffic is checked for the next trip at 900. The traffic is displayed along the user route and the fastest route at 910. Thereafter, the method may end at 920.

If, however, the user does not enter the next trip rather the user enters another trip at 890, the traffic is checked for the route to the alternate trip at 930. The traffic is displayed along the user route and the fastest route at 940. Thereafter, the method may end at 920.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of communicating navigation information to a user, comprising:
determining a trip that is performed by a vehicle;
determining a time and a route associated with the trip; and
sending the time and the route associated with the trip from the vehicle to a wireless electronic device.

2. The method of claim 1, further comprising:
determining a user of the vehicle; and
associating the time and the route of the trip with the user of the vehicle.

3. The method of claim 2, wherein the determining the user of the vehicle is based on an identifier of the wireless electronic device.

4. The method of claim 2, wherein the determining the user of the vehicle is based on the wireless electronic device being in proximity to the vehicle.

5. The method of claim 1, wherein the determining the trip is based on a calendar event.

6. The method of claim 1, wherein the determining the trip is based on a searched destination.

7. The method of claim 1, wherein the determining the trip is based on a frequency of the trip.

8. The method of claim 1, further comprising providing a notification by the wireless electronic device to a user based on the time and the route associated with the trip.

9. The method of claim 8, wherein the notification comprises a time delay associated with the trip.

10. The method of claim 8, wherein the notification comprises traffic activity associated with the trip.

11. The method of claim 8, wherein the notification comprises an alternate route associated with the trip.

12. A method of communicating navigation information to a user, comprising:
receiving, by a wireless electronic device, a time and a route that is associated with a trip that has been performed by a vehicle; and
generating by the wireless electronic device, a notification to a user based on the time and the route that is associated with the trip.

13. The method of claim 12, further comprising determining a current traffic activity associated with the trip, wherein the notification comprises a current traffic activity associated with the trip.

14. The method of claim 13, wherein the determining the current traffic activity is based on the time associated with the trip.

15. The method of claim 14, wherein the determining the current traffic activity associated with the trip comprises determining the current traffic activity at a predetermined time before the time that is associated with the trip.

16. The method of claim 13, wherein the determining the current traffic activity is based on the route associated with the trip.

17. The method of claim 12, further comprising determining a current time delay associated with the trip, and wherein the notification comprises the current time delay associated with the trip.

18. The method of claim 17, wherein the determining the current time delay is based on the time associated with the trip.

19. The method of claim 18, wherein the determining the current time delay associated with the trip comprises determining the current time delay at a predetermined time before the time that is associated with the trip.

20. The method of claim 13, wherein the determining the current time delay is based on the route that is associated with the trip.

21. The method of claim 20, further comprising determining a current traffic activity along the route that is associated with the trip and wherein the determining the current time delay is based on the current traffic activity along the route that is associated with the trip.

22. The method of claim 12, further comprising determining an alternate route associated with the trip, and wherein the notification comprises the alternate route associated with the trip.
